(19) United States
(12) Patent Application Publication
(10) Pub. No.: US 2005/0251376 A1
(43) Pub. Date: Nov. 10, 2005

(54) Simulating operation of an electronic circuit

(76) Inventors: Alexander Pekker, Santa Rosa, CA (US); David E. Root, Santa Rosa, CA (US); John Wood, Santa Rosa, CA (US)

Correspondence Address: AGILENT TECHNOLOGIES, INC .;Legal Department, DL 429, Intellectual Property Administration, P.O. Box 7599, Loveland, CO, 80537-0599, US

(21) Appl. No.: 10/843,532

(22) Filed: May 10, 2004

(51) Int. Cl. G06F 17/50

(52) U.S. Cl. 703/14

(57) ABSTRACT

Operation of an electronic circuit is simulated. A plurality of data points representing operation of the electronic circuit at a plurality of operating conditions is obtained. A boundary that encompasses the plurality of data points is constructed. The boundary defines a bounded domain of operating conditions for the electronic circuit. A model function representing operation of the electronic circuit within and without the bounded domain of operating conditions is produced. The model function is determined within the bounded domain of operating conditions. The model function is extended outside the bounded domain so that all first order partial derivatives of the model function for operating conditions located outside and not near the boundary are large and positive. The model function is utilized to simulate operation of the electronic circuit.

### BACKGROUND

Most circuit simulation nonlinear models of electronic components, such as transistors, amplifiers, mixers, and nearly all nonlinear functional blocks, require the specification of one or more nonlinear functions of the controlling variables. For example, a non-linear simulator can model the drain-source current (Ids) of a field effect transistor (FET) as a function of the two controlling variables: gate-source voltage (Vgs) and drain-source voltage (Vds).

The underlying solution algorithms used by the simulator to solve nonlinear circuit equations, impose mathematical constraints on the model functions. For example, non-linear simulators whose solution algorithms are based on variants of Newton's method require that such a model function for Ids be defined for all values of Vgs and Vds. This is true even for values of Vgs and Vds at which a converged solution for Ids will not be evaluated.

The reason for Ids being defined for all values of Vgs and Vds is that in the process of convergence, the simulator will update the values of Vgs and Vds as the simulator iterates towards a solution for Ids. The updated values of Vgs and Vds at any particular iteration can take any value.

Another imposed mathematical constraint is that the model functions must be differentiable and the partial derivatives must be bounded. This is necessary in order for the Newton-based numerical solution algorithms of the simulator to solve nonlinear circuit equations. Furthermore, it is often required that the model functions have higher order derivatives, if the model is to give accurate representations of figures of merit such as third order distortion or adjacent channel power ratio (ACPR), which can be directly related to partial derivatives of transfer functions in the small-signal asymptotic regime.

A difficulty in creating model functions is to provide such globally defined, continuous and differentiable functions necessary to meet the simulator requirements, and that are flexible enough to represent accurately real device nonlinear characteristics.

A conventional approach for device modeling is to use the closed-form expressions of simplified physics to model electronic components. However, these expressions are often too simple to represent accurately the measured characteristics of modern transistors and other nonlinear components. More detailed physics is often too complicated to be distilled into efficient circuit simulation models. Moreover, the parameter values of detailed physics-based models are often unknown or too difficult to determine.

Measurement-based models present an attractive alternative to physically-based nonlinear device models or closed-form analytical behavioral models. It is often easier to measure, using modern electronic instrumentation, the actual device characteristics, such as field effect transistor (FET) current-voltage (I-V) characteristics, such as the FET Ids mentioned above, and other transfer functions, and use this information more directly in the simulation models to predict the component performance under different conditions or when devices are combined into a circuits. The idea is to use the measured device data as directly as possible in the model of the nonlinear component. However, actual device data is defined on a discrete, bounded domain, such as the particular values of the drain-source current at the finite set of Vgs and Vds values at which the measurements are performed. It is then necessary, for the simulator, to transform this discrete, bounded data into a mathematical form consistent with the globally defined, continuous, and differentiable properties as discussed above.

A major limitation of conventional measurement-based nonlinear modeling approaches are the algorithms that convert the discrete, bounded, measured data into continuous and differentiable functions defined everywhere as required for the simulator solution algorithms to converge. Common approaches are interpolating or smoothing splines, polynomial fitting routines, radial basis functions and artificial neural networks. Interpolation is sensitive to noise on the data, and can result in spurious distortion due to the nonlinear characteristics of the interpolant between data samples. Polynomial fitting is efficient and works for arbitrary dimensions (number of variables). However, polynomial approximation can be numerically unstable, and polynomial models diverge rapidly outside a bounded domain. Radial basis functions have certain advantages, but do not approximate functions well with very low distortion in certain regions. Moreover, none of the methods listed here account well for how the model functions are defined beyond the finite set of the measured data. Since the simulator may require such information (outside the data domain) in its quest for a solution, the properties of the model functions outside the data domain can be critical to the convergence or lack thereof.

### SUMMARY OF THE INVENTION

In accordance with an embodiment of the present invention, operation of an electronic circuit is simulated. A plurality of data points representing operation of the electronic circuit at a plurality of operating conditions is obtained. A boundary that encompasses the plurality of data points is constructed. The boundary defines a bounded domain of operating conditions for the electronic circuit. A model function representing operation of the electronic circuit within and without the bounded domain of operating conditions is produced. The model function is determined within the bounded domain of operating conditions. The model function is extended outside the bounded domain so that all first order partial derivatives of the model function for operating conditions located outside and not near the boundary are large and positive. The model function is utilized to simulate operation of the electronic circuit.

### BRIEF DESCRIPTION OF THE DRAWINGS

FIG. 1 is a block diagram illustrating data from a data source being converted to continuous and differentiable functions for use in a simulation model in accordance with an embodiment of the present invention.

FIG. 2 is a flow chart describing a conversion process in accordance with an embodiment of the present invention.

FIG. 3 shows a simplified example of a discrete domain of data from which continuous and differentiable functions are derived.

FIG. 4 shows a boundary placed around the discrete domain of data shown in FIG. 2 in accordance with an embodiment of the present invention.

FIG. 5 illustrates calculation of extensions to the bounded discrete domain of data shown in FIG. 3 in accordance with an embodiment of the present invention.

FIG. 6 shows an example of an electronic component being simulated in accordance with an embodiment of the present invention.

### DESCRIPTION OF THE EMBODIMENT

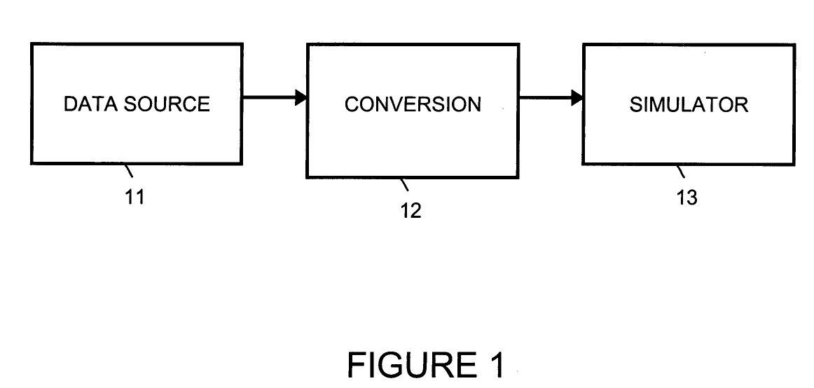

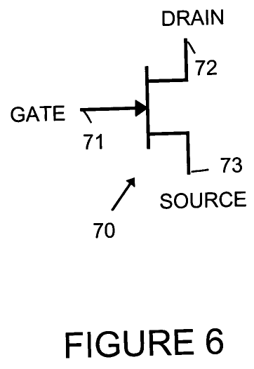

FIG. 1 is a block diagram showing a data source 11 producing discrete bounded data from measurements or simulation of the operation of circuits (e.g., electronic components or circuitry) at various operating conditions. The discrete, bounded data is in any number of dimensions. For example, data source 11 is an electronic instrument, such as an Agilent 4142B Modular DC source/monitor, that measures variables and output from an electronic component, such as an FET. For example, in the case where that data is performance data for an FET, the electronic instrument measures values of Ids for various values of Vgs and Vds. For example, FIG. 6 shows an FET 70 having a gate 71, a drain 72 and a source 73.

Alternatively, data source 11 can be a simulator or some other device that produces values for variables and output representative of the operation of an electronic component or circuit.

Conversion block 12, converts data from data source 11 to functions that are, for example, everywhere defined, continuously differentiable at the boundary, infinitely differentiable within the domain and that can be readily used in accurate and robust measurement-based simulation models in a simulator 13. For example, circuit simulator 13 is a nonlinear circuit simulator such as an Agilent Advanced Design System (ADS) available from Agilent Technologies, Inc, or Simulation Program with Integrated Circuit Emphasis (SPICE).

Conversion block 12 forms model functions using a generic procedure and set of algorithms that transform discrete, bounded measured or simulated data into model functions that are suitable for robust nonlinear circuit simulation. The model functions are continuous, differentiable, and globally defined, both within and beyond the domain of the data. The model functions are defined in such a way as to accelerate and improve the convergence of the simulation itself. For example, the model functions are defined so that convergence occurs even if simulator 13 wanders outside the domain of the data on some iterations.

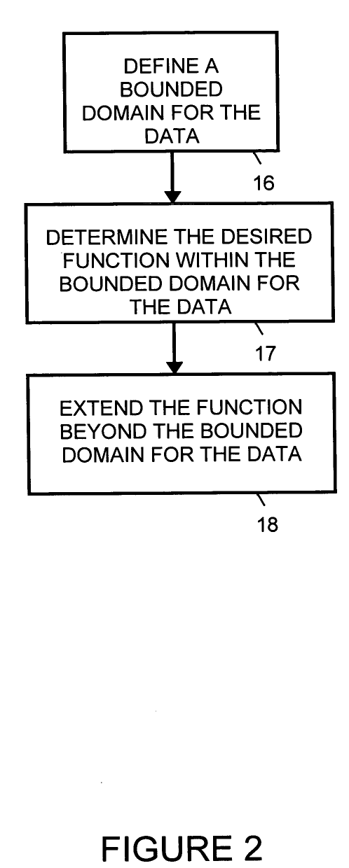

FIG. 2 is a flowchart describing operation of conversion block 12. In a step 16, conversion block 12 associates a boundary for the domain of the data from data source 11. The boundary defines a bounded domain of the data from data source 11. For example, the standard computational geometrical construction of the convex hull is used for this purpose. See for example, Barber, C. B., D. P. Dobkin, and H. T. Huhdanpaa, “The Quickhull Algorithm for Convex Hulls,” ACM Transactions on Mathematical Software, Vol. 22, No. 4, Dec. 1996, p. 469-483. For a discrete set of data, in any dimension, the standard computational geometrical construction of the convex hull is a unique construction. For an analytical model, a convex subset can be chosen to define the region of validity.

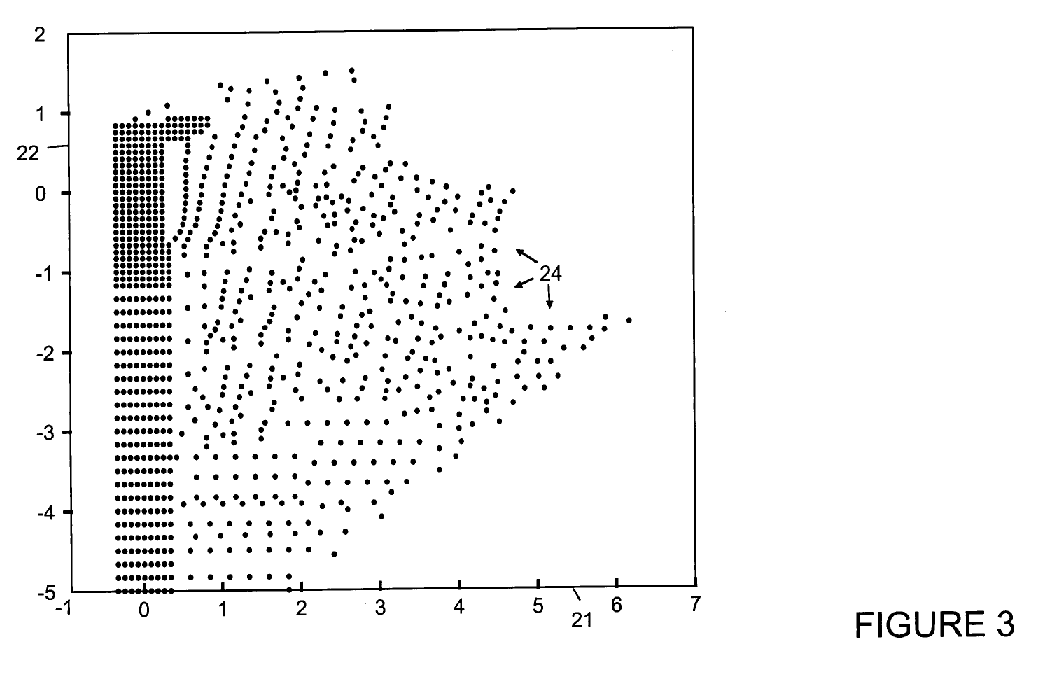

FIG. 3 shows an example of a two-dimensional set of FET data points 24. An axis 21 represents Vgs. An axis 22 represents Vds. Each of data points 24 represents a controlling variable pair (Vgs,Vds) for which a measurement (or simulation) for Ids has been made.

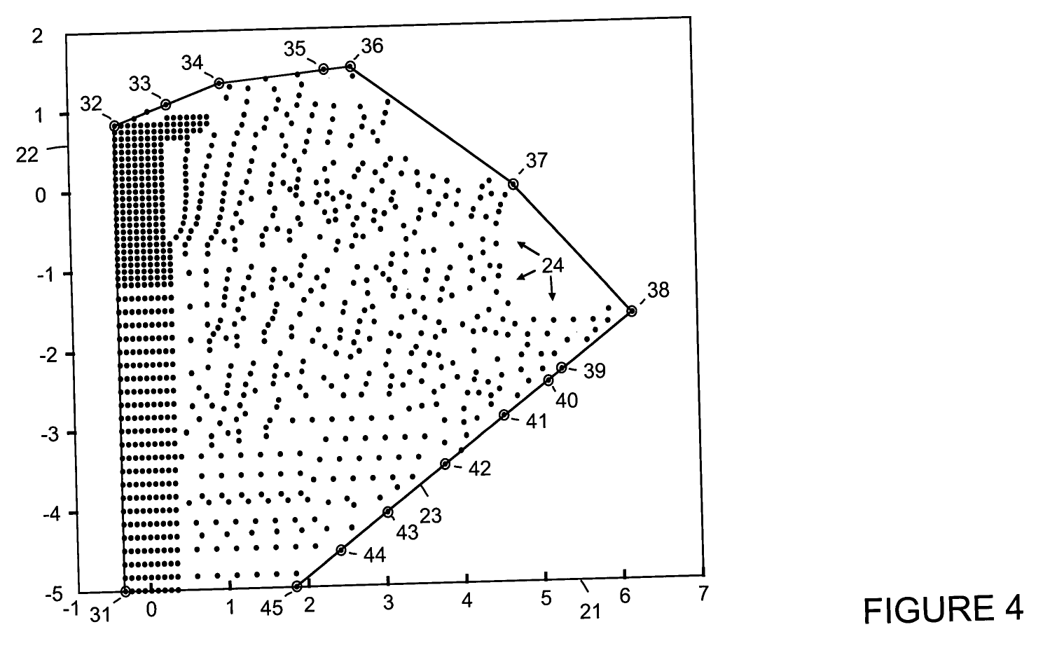

FIG. 4 shows a boundary 23 placed around the domain of data points 24. Boundary definitions data points 31, 32, 33, 34, 35, 36, 37, 38, 39, 40, 14, 42, 43, 44 and 45 are located on boundary 23. For example, boundary 13 is computed using the standard computational geometrical construction of the convex hull.

In a step 17 (shown in FIG. 2), conversion block 12 (shown in FIG. 1) determines a desired model function within the bounded domain defined in step 16 and defined in FIG. 4 by boundary 23. Conversion block 12 determines the desired model function either by evaluating a known continuous and differentiable function that is defined within the bounded domain or by approximating the discrete data by a continuous and differentiable function within the bounded domain.

Conversion block 12 converts the discrete data within the bounded domain into continuous and differentiable functions defined for data points within the continuous and bounded domain. A suitable set of basis functions are used to determine the model function within the bounded domain. For example, this is done using one of the many techniques known in the art, such as spline interpolation, polynomial fitting, radial basis functions, cluster-weighted models, rational functions, Pade functions or artificial neural networks (ANN), etc. In the description below, ANN is used because of their robust and infinitely differentiable properties. For a general discussion on use of ANN to produce a model function within a bounded domain of data, see S. Haykin, Neural Networks: A Comprehensive Foundation, 2nd Ed. Prentice-Hall (1998); or I.W. Sandberg, J. T. Lo, C. L. Fancourt, J. C. Principe, S. Katagiri, S. Haykin, Nonlinear Dynamical System: Feedforward Neural Network Perspectives, Wiley (2001).

In a step 18 (shown in FIG. 2), conversion block 12 (shown in FIG. 1) extends the continuous and differentiable functions beyond the bounded domain in a suitable way so as to ensure convergence of simulator 13. The extension of the continuous and differentiable functions accelerates the numerical convergence of simulator 13. The extension of the continuous and differentiable functions also achieves specific asymptotic properties for the model function that force simulator 13 back within the bounded domain of the data.

The resulting model function sent from conversion block 12 to simulator 13 is a nonlinear constitutive relation with a smooth, infinitely differentiable function (e.g., ANN) within the bounded domain. The region of validity is automatically constructed by the boundary. The extension is implemented as a guided extrapolation beyond the bounded domain. The guided extrapolation is provided with sufficient smoothness for nonlinear simulation.

In the given example of an extension described below, ANN is used to define the model function within the bounded domain. Alternatively, as discussed above, any differentiable approximating (or interpolating) function defined within the bounded domain (convex hull) could be used.

The extension is defined, for example, as follows: A point of N dimensions, \vec{X}_{C}=(X_{C}¹,X_{C}², . . . X_{C}^{N}), within the bounded domain, is selected (superscripts are coordinates—components of the vector). The point (\vec{X}_{C}) is, for example, a point closest to the centroid of the bounded domain of data. However, it is not critical that the point (\vec{X}_{C}) be the point closest to the centroid of the bounded domain. Another point within the bounded domain can be chosen as the point (\vec{X}_{C}). The model function within the bounded domain is independent of the location of the point \vec{X}_{C}. For a given point \vec{X}ᵢ=(Xᵢ¹,Xᵢ², . . . Xᵢ^{N}) outside the bounded domain, a unique point, \vec{X}₀ᵢ, is defined as the intersection of a line from \vec{X}_{C} to \vec{X}ᵢ and the boundary.

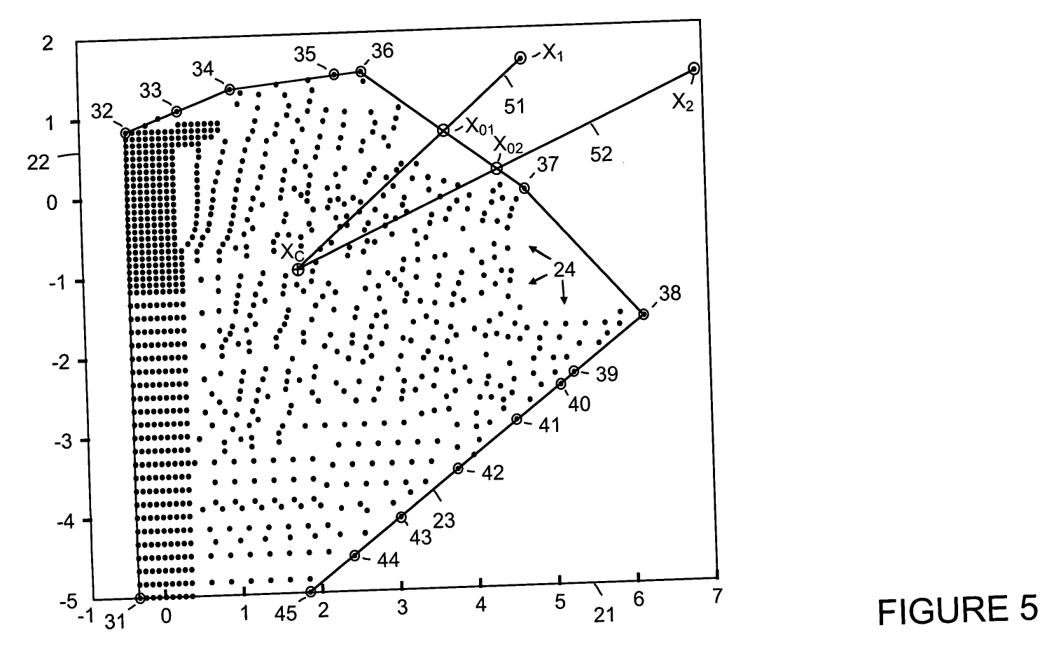

For example, FIG. 5 shows examples of two points, \vec{X}₁ and \vec{X}₂, outside boundary 23. A unique point, \vec{X}₀ᵢ, is shown to be the intersection of a line 51 from \vec{X}_{C} to \vec{X}₁ and boundary 23. A unique point, \vec{X}₀₂, is shown to be the intersection of a line 52 from \vec{X}_{C} to \vec{X}₂ and boundary 23. In the example shown in FIG. 5, N equals 2.

For example, f (\vec{x}) is the model function defined only within the bounded domain. That is, f (\vec{x}) is the result of determining (e.g., fitting or interpolating) the data provided the point, \vec{x}, is within the bounded domain. The full model function, F(\vec{x}) defined everywhere, is defined by Equation 1 below:

Equation 1

If \vec{x} is within the bounded domain

then

F(\vec{x}) = f(\vec{x})

else (\vec{x} is outside or on the boundary)

$F ( \vec{x} ) = f ( {\vec{x}}_{0} ) + ∇ f ( {\vec{x}}_{0} ) \cdot ( \vec{x} - {\vec{x}}_{0} ) + β \cdot {\sum }_{n = 1}^{N} ext ( {x}^{n} , {x}_{0}^{n} , {α}^{n} )$

where

$ext ( {x}^{n} , {x}_{0}^{n} , {α}^{n} ) = If ( {x}^{n} > {x}_{0}^{n} )$

$\begin{matrix}Then {( {x}^{n} - {x}_{0}^{n} )}^{2} \cdot softExp ( {α}^{n} \cdot ( {x}^{n} - {x}_{0}^{n} ) ) \\ Then {( {x}^{n} - {x}_{0}^{n} )}^{2} \cdot softExp ( {α}^{n} \cdot ( {x}^{n} - {x}_{0}^{n} ) )\end{matrix}$

In Equation 1 above, “softExp” is the exponential function linearized at sufficiently large values of its argument as will be understood by persons of ordinary skill in the art. The parameters αⁿ and β are real positive numbers. The parameters αⁿ are used to control the rates of the exponentials. β is used make the units consistent for the Function F(\vec{x}). As mentioned above, superscripts are coordinates, thus there can be a different value of an for each of the components:
(αⁿ·(xⁿ−x₀ⁿ)) and (−αⁿ·(xⁿ−x₀ⁿ)), in Equation 1.

Function F(\vec{x}) is continuous at the boundary and the first partial derivatives are continuous. Function F(\vec{x}) is piece-wise differentiable everywhere except for a set of measure zero where \vec{X}₀ falls exactly on a data point which happens to be a cusp of the boundary.

The key mathematical property for Function F(\vec{x}) calculated outside or on the boundary is that for points far outside the bounded domain, all first order partial derivatives of Function F(\vec{x}) are large and positive. The large, positive conductances push simulator 13 back towards the boundary if a guess is taken outside. Within the bounded domain, Function F(\vec{x}) is identical to the approximation based on the choice of interpolation algorithm or choice of basis functions(ANN was used in this example). Function F(\vec{x}) defines a global function which, at the boundary, has (piece-wise) second order partial derivative continuity and transitions between linear extrapolation and exponential.

The behavior of any model defined within its boundary and extended by using the Equation 1 behaves as if anti-parallel diodes are connected between each pair of nodes of the equivalent circuit. Connecting individual diodes between pairs of nodes is known to help convergence problems. However, the number of pairs of nodes explodes as N². Using equation 1, achieves the same effect with order N additions. More important, equation 1 automatically achieves this for an arbitrarily complicated set of data-points, for which no automated solution was possible before. Also, the “diodes” as described by Equation 1 do not affect the model within the bounded domain at all, whereas any actual attachments of diodes would perturb the model, slightly, within the bounded domain.

This approach can be used by user of simulator 13, without the need to modify any of the convergence algorithms of simulator 13. This approach can be used as a “wrapper” around any model that may be well-defined on a finite, bounded domain, but which may not lead to robust convergence in simulator 13 because of non-optimal behavior of the model functions outside the domain of validity. That is, equation 1 is useful for any nonlinear model, physics based or empirical, which is known to be valid over a restricted domain. In this case equation 1 applies to the recognition of the boundary and the suitable extension of the model functions beyond the boundary to make the convergence more robust. This is particularly important, since many different parameter sets for, for example ANN, may fit equally well inside the domain or region of validity, but will give vastly different behavior outside the domain of validity. Since this behavior outside the region of validity determines how simulator 13 converges, it is critical to define the function extension outside this range properly.

Conversion block 12 makes much easier the job of the user of simulator 13. When measurement-based data is used for modeling, the modeler is freed from excessive concern about how large a domain in which to take measurements. Too little data for spline-based models can lead to non-convergence when simulator 13 goes beyond the data and the polynomial splines do not extrapolate sensibly. While expensive measurement equipment, such as pulsed current voltage (I-V) systems, can be used to increase the measurement domain for more robust to convergence models, this helps, but does not eliminate the problem of non-convergence.

Conversion block 12 also allows the empirical modeler to use many existing, simple techniques that are only valid in a restricted domain, such as polynomial fitting. Conversion block 12 deals with the model beyond the boundary of the domain of validity. This saves time, and allows existing tools and techniques to be used where they are valid.

The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

1. A system comprising:
a data generation source that generates a plurality of data points representing operation of an electronic circuit at a plurality of operating conditions;
a conversion device that constructs a boundary that encompasses the plurality of data points, the boundary defining a bounded domain of operating conditions for the electronic circuit, wherein the conversion device produces a model function representing operation of the electronic circuit within and without the bounded domain of operating conditions, the model function approximating operation of the electronic circuit within the bounded domain of operating conditions and being extended outside the bounded domain so that all first order partial derivatives of the model function for operating conditions located outside and not near the boundary are large and positive; and,
a simulator that uses the model function to simulate operation of the electronic circuit.

2. A system as in claim 1 wherein at the boundary the model function and first partial derivatives of the model function are continuous.

3. A system as in claim 1 wherein the data generation source obtains the plurality of data points by simulating performance of the electronic circuit in the plurality of operating conditions.

4. A system as in claim 1 wherein conversion device constructs the boundary using geometrical construction of a convex hull.

5. A system as in claim 1 wherein the model function is determined within the bounded domain of operating conditions using artificial neural networks.

6. A system as in claim 1 wherein the model function is determined within the bounded domain of operating conditions using one of the following techniques:
spline interpolation;
polynomial fitting;
radial basis functions;
cluster-weighted models;
rational functions;
Pade functions.

7. A system as in claim 1 wherein the model function has a form of the equation listed below:
If \vec{x} is within the bounded domain
then
F(\vec{x}) = f(\vec{x})
else (\vec{x} is outside the bounded domain or on the boundary)
$F ( \vec{x} ) = f ( {\vec{x}}_{0} ) + ∇ f ( {\vec{x}}_{0} ) \cdot ( \vec{x} - {\vec{x}}_{0} ) + β \cdot {\sum }_{n = 1}^{N} ext ( {x}^{n} , {x}_{0}^{n} , {α}^{n} )$
where
$ext ( {x}^{n} , {x}_{0}^{n} , {α}^{n} ) = If ( {x}^{n} > {x}_{0}^{n} )$
$\begin{matrix}Then {( {x}^{n} - {x}_{0}^{n} )}^{2} \cdot softExp ( {α}^{n} \cdot ( {x}^{n} - {x}_{0}^{n} ) ) \\ Then {( {x}^{n} - {x}_{0}^{n} )}^{2} \cdot softExp ( {α}^{n} \cdot ( {x}^{n} - {x}_{0}^{n} ) )\end{matrix}$
and where f (\vec{x}) is the model function defined within the bounded domain, softExp is an exponential function, and parameters α and β are real positive numbers.

8. A method for simulating operation of an electronic circuit comprising:
obtaining a plurality of data points representing operation of the electronic circuit at a plurality of operating conditions;
constructing a boundary that encompasses the plurality of data points, the boundary defining a bounded domain of operating conditions for the electronic circuit;
producing a model function representing operation of the electronic circuit within and without the bounded domain of operating conditions, including:
determining the model function within the bounded domain of operating conditions, and
extending the model function outside the bounded domain so that all first order partial derivatives of the model function for operating conditions located outside and not near the boundary are large and positive; and,
utilizing the model function to simulate operation of the electronic circuit.

9. A method as in claim 8 wherein the plurality of data points are obtained by placing the electronic circuit in the plurality of operating conditions and making measurements of performance of the electronic circuit.

10. A method as in claim 8 wherein the plurality of data points are obtained by simulating performance of the electronic circuit in the plurality of operating conditions.

11. A method as in claim 8 wherein the boundary is constructed using geometrical construction of a convex hull.

12. A method as in claim 8 wherein the model function is determined within the bounded domain of operating conditions using artificial neural networks.

13. A method as in claim 8 wherein at the boundary the model function and first partial derivatives of the model function are continuous.

14. A method as in claim 8 wherein the model function has a form of the equation listed below:
If \vec{x} is within the bounded domain
then
F(\vec{x}) = f(\vec{x})
else (\vec{x} is outside the bounded domain or on the boundary)
$F ( \vec{x} ) = f ( {\vec{x}}_{0} ) + ∇ f ( {\vec{x}}_{0} ) \cdot ( \vec{x} - {\vec{x}}_{0} ) + β \cdot {\sum }_{n = 1}^{N} ext ( {x}^{n} , {x}_{0}^{n} , {α}^{n} )$
where
$ext ( {x}^{n} , {x}_{0}^{n} , {α}^{n} ) = If ( {x}^{n} > {x}_{0}^{n} )$
$\begin{matrix}Then {( {x}^{n} - {x}_{0}^{n} )}^{2} \cdot softExp ( {α}^{n} \cdot ( {x}^{n} - {x}_{0}^{n} ) ) \\ Then {( {x}^{n} - {x}_{0}^{n} )}^{2} \cdot softExp ( {α}^{n} \cdot ( {x}^{n} - {x}_{0}^{n} ) )\end{matrix}$
and where f(\vec{x}) is the model function defined within the bounded domain, softExp is an exponential function, and parameters α and β are real positive numbers.

15. A method for simulating operation of an electronic circuit comprising:
constructing a boundary that encompasses a plurality of data points representing operation of the electronic circuit at a plurality of operating conditions, the boundary defining a bounded domain of operating conditions for the electronic circuit; and,
producing a model function representing operation of the electronic circuit within and without the bounded domain of operating conditions, including:
determining the model function within the bounded domain of operating conditions, and
extending the model function outside the bounded domain so that all first order partial derivatives of the model function for operating conditions located outside and not near the boundary are large and positive.

16. A method as in claim 15 wherein the boundary is constructed using geometrical construction of a convex hull.

17. A method as in claim 15 wherein the model function is determined within the bounded domain of operating conditions using artificial neural networks.

18. A method as in claim 15 wherein the model function is determined within the bounded domain of operating conditions using one of the following techniques:
spline interpolation;
polynomial fitting;
radial basis functions;
cluster-weighted models;
rational functions;
Pade functions.

19. A method as in claim 15 wherein the model function has a form of the equation listed below:
If \vec{x} is within the bounded domain
then
F(\vec{x}) = f(\vec{x})
else (\vec{x} is outside the bounded domain or on the boundary)
$F ( \vec{x} ) = f ( {\vec{x}}_{0} ) + ∇ f ( {\vec{x}}_{0} ) \cdot ( \vec{x} - {\vec{x}}_{0} ) + β \cdot {\sum }_{n = 1}^{N} ext ( {x}^{n} , {x}_{0}^{n} , {α}^{n} )$
where
$ext ( {x}^{n} , {x}_{0}^{n} , {α}^{n} ) = If ( {x}^{n} > {x}_{0}^{n} )$
$\begin{matrix}Then {( {x}^{n} - {x}_{0}^{n} )}^{2} \cdot softExp ( {α}^{n} \cdot ( {x}^{n} - {x}_{0}^{n} ) ) \\ Then {( {x}^{n} - {x}_{0}^{n} )}^{2} \cdot softExp ( {α}^{n} \cdot ( {x}^{n} - {x}_{0}^{n} ) )\end{matrix}$
and where f (\vec{x}) is the model function defined within the bounded domain, softExp is an exponential function, and parameters α and β are real positive numbers.

20. A method as in claim 15 additionally comprising:
performing a simulation of the operation of the electronic device using the model function.
